(19) United States
(12) Patent Application Publication
(10) Pub. No.: US 2008/0002533 A1
(43) Pub. Date: Jan. 3, 2008

(54) Information recording and reproducing apparatus, and information recording and reproducing method

(76) Inventors: Takahiro Nango, Tokyo (JP); Koichi Otake, Yokohama-shi (JP); Yukiyasu Tatsuzawa, Yokohama-shi (JP); Hiroyuki Moro, Tokyo (JP); Toshifumi Yamamoto, Sagamihara-shi (JP); You Yoshioka, Tokyo (JP); Hiroaki Morino, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/821,207

(22) Filed: Jun. 22, 2007

(30) Foreign Application Priority Data
Jun. 30, 2006 (JP) P2006-182447

(51) Int. Cl. G11B 20/18

(52) U.S. Cl. 369/30.22

(57) ABSTRACT

According to one embodiment, in an information recording and reproducing apparatus, a record data correction unit generates correction data for correcting a record waveform generated according to record data. Further, the information recording and reproducing apparatus generates discrimination data for use in pattern discrimination performed to generate the correction data, using decoded data outputted from a PRML signal processing unit and the record data, and outputs the generated discrimination data to the record data correction unit.

### CROSS-REFERENCE TO RELATED APPLICATIONS

This application is based upon and claims the benefit of priority from Japanese Patent Application No. 2006-182447, filed Jun. 30, 2006, the entire contents of which are incorporated herein by reference.

### BACKGROUND

1. Field

One embodiment of the invention relates to an information recording and reproducing apparatus and an information recording and reproducing method each for recording and reproducing information using an optical disk.

2. Description of the Related Art

Conventional examples of a recording medium capable of recording digital data thereon and reproducing therefrom include optical disks as represented by a DVD (digital versatile disk). Of them, the optical disk, for example, a DVD-RAM that is one of the DVD family has a recording layer for signals incorporated in the recording medium (disk) so that laser light having appropriate energy is applied to the recording layer to change the crystal state in the recording layer, and laser light having appropriate energy is applied again to the recording layer to obtain an amount of reflected light corresponding to the crystal state in the recording layer. The reflected light is detected to reproduce the digital data.

In the conventional information recording and reproducing apparatus, a technology called recording and learning might have been employed to optimize the write state at the time of recording. The recording and learning is to record test data on a trial basis before recording digital data, and evaluate the quality of a reproduced signal obtained by reading the test data from the recording medium, then correct the digital data to be recorded. Relating to the information recording and reproducing apparatus including a circuit for performing the recording and learning (a recording and learning circuit), there has conventionally been an information recording and reproducing apparatus disclosed in Japanese Patent Application Publication(KOKAI)No. 2005-332571 (Patent Document 1).

In this information recording and reproducing apparatus, the recording and learning circuit is configured as follows. The recording and learning circuit includes a pattern discriminator in which several kinds of previously set patterns are registered, an ideal signal calculation device for generating an ideal reproduced signal (hereinafter referred to as an “ideal signal”) according to PR characteristic (Partial Response Characteristic) to be applied, a distance calculator for calculating the distance difference between the ideal signal and the reproduced signal, and a parameter calculation unit for calculating a waveform compensation amount of a record waveform based on the calculated distance difference.

In the recording and learning circuit, the pattern discriminator then discriminates a pattern which matches inputted record data, and the ideal signal calculation device generates an ideal signal according to the discriminated pattern. Further, the distance calculator calculates the distance difference between the ideal signal and the reproduced signal adjusted in phase so that the parameter calculation unit calculates the waveform compensation amount based on the calculated distance difference.

Patent Document 1 also discloses an information recording and reproducing apparatus in which the pattern discriminator performs pattern discrimination using the decoded data outputted from a Viterbi decoder instead of the record data in consideration of the case where phase adjustment of the reproduced signal is difficult.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a circuit configuration in an information recording and reproducing apparatus according to an embodiment of the invention;

FIG. 2 is an exemplary diagram showing an example of the structure of recording data including VFO generated in a recording system circuit in the embodiment;

FIG. 3 is an exemplary block diagram showing an example of the circuit configuration in an NRZI synchronization circuit in the embodiment;

FIG. 4 is an exemplary block diagram showing an example of the data structure of record data and the data structure of Viterbi decoded data in the embodiment;

FIG. 5 is an exemplary flowchart showing the operation procedure of mode selection processing performed by a selection unit constituting the NRZI synchronization circuit in the embodiment; and

FIG. 6 is an exemplary diagram showing examples of generated waveforms, (a) showing a reference clock, (b) showing an NRZI waveform, and (c) showing a record waveform in the embodiment.

### DETAILED DESCRIPTION

Various embodiments according to the invention will be described hereinafter with reference to the accompanying drawings. In general, according to one embodiment of the invention, in an information recording and reproducing apparatus, a record data correction unit generates correction data for correcting a record waveform generated according to record data. Further, the information recording and reproducing apparatus generates discrimination data for use in pattern discrimination performed to generate the correction data, using decoded data outputted from a PRML signal processing unit and the record data, and outputs the generated discrimination data to the record data correction unit.

(Configuration of Information Recording and Reproducing Apparatus)

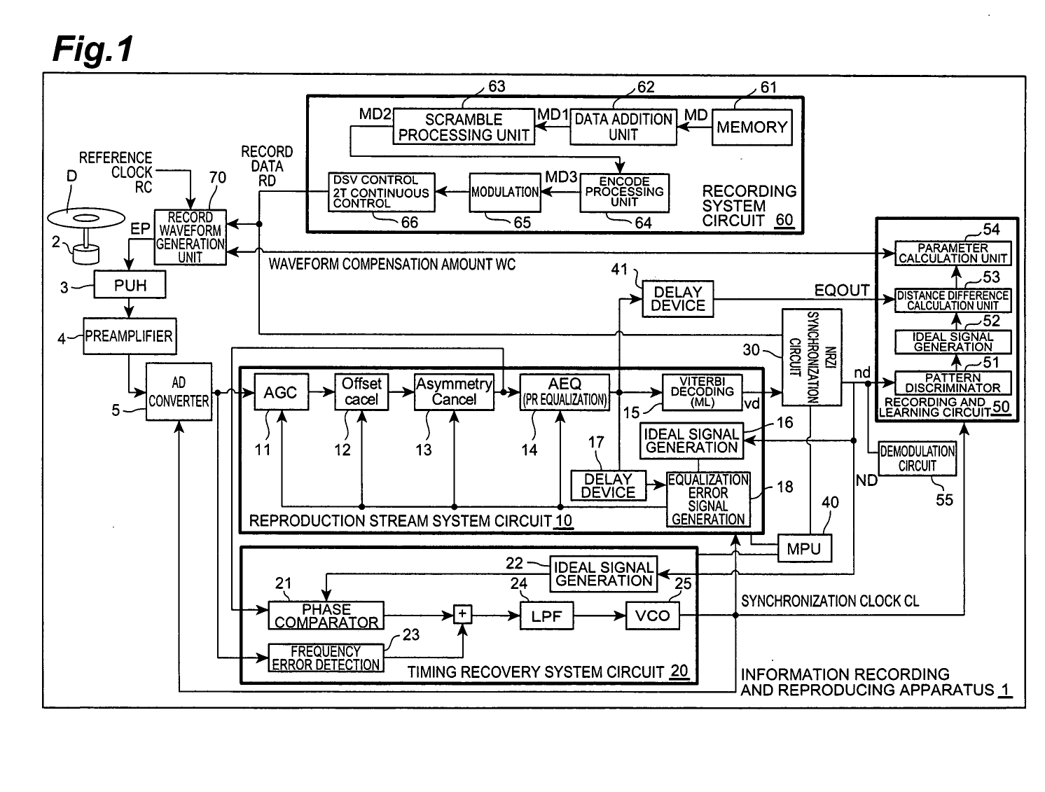

An information recording and reproducing apparatus 1 according to an embodiment of the present invention employs an optical disk D as a recording medium as shown in FIG. 1 and is capable of reproducing digital data recorded on the optical disk D and recording digital data on the optical disk D. The information recording and reproducing apparatus 1 has a drive mechanism 2 for holding the optical disk D and rotating it at a predetermined number of rotations, a PUH (Pick up head) 3 including an optical pickup or the like, and a preamplifier 4.

The PUH 3 applies appropriate laser light to the optical disk D, detects its reflected light from the optical disk D, and outputs a reproduced signal as a weak analogue signal to the preamplifier 4. The preamplifier 4 performs processing such as amplification and the like on the reproduced signal outputted from the PUH 3 and outputs the reproduced signal which has reached a sufficient signal level, to a not-shown pre-equalizer. The pre-equalizer performs previous waveform equalization on the analogue reproduced signal which has been subjected to the processing such as amplification and the like in the preamplifier 4, and outputs the analogue reproduced signal after the waveform equalization. These PUH 3, preamplifier 4, and not-shown pre-equalizer constitute a reproduced signal output unit.

Further, the information recording and reproducing apparatus 1 has an AD converter 5, a reproduction stream system circuit 10, a timing recovery system circuit 20, and an NRZI synchronization circuit 30. Further, the information recording and reproducing apparatus 1 has an MPU 40, a delay device 41, a recording and learning circuit 50, a recording system circuit 60, and a record waveform generation unit 70.

The AD converter 5 converts the level value of the inputted analogue reproduced signal into a digital value and outputs the digital reproduced signal.

The reproduction stream system circuit 10 has a function as a PRML signal processing unit for performing signal processing by the PRML system on the digital reproduced signal outputted from the AD converter 5.

In the reproduction stream system circuit 10, an AGC circuit 11 detects an amplitude error of the digital reproduced signal and controls the signal to an appropriate amplitude, an offset cancel circuit 12 detects and removes an offset component of the controlled digital reproduced signal, and further an asymmetry cancel circuit. 13 detects and removes an asymmetry component of the signal.

For the digital reproduced signal thus obtained, an adaptive equalizer 14 performs waveform equalization to create a response of PR characteristic to be applied. Based on the reproduced signal after the waveform equalization outputted from the adaptive equalizer 14, a Viterbi decoder 15 performs maximum likelihood sequence estimation (Viterbi decoding) so that binarized Viterbi decoded data vd is outputted from the Viterbi decoder 15.

Further, in the reproduction stream system circuit 10, an ideal signal generation unit 16 generates an ideal signal using later-described NRZI data nd outputted from the NRZI synchronization circuit 30. An equalization error signal generation unit 18 generates an equalization error signal using the generated ideal signal and a delayed output signal generated by a delay device 17 delaying the output signal from the adaptive equalizer 14.

Furthermore, in the reproduction stream system circuit 10, the AGC circuit 11, the offset cancel circuit 12, the asymmetry cancel circuit 13, and the adaptive equalizer 14 are controlled based on the equalization error signal generated by the equalization error signal generation unit 18.

Next, in the timing recovery system circuit 20, a phase comparator 21 performs phase comparison of the digital reproduced signal outputted from the AD converter 5 with the output signal from the asymmetry cancel circuit 13 to detect phase error information. Into the phase comparator 21, an ideal signal is inputted which is generated by an ideal signal generation circuit 22 based on the NRZI data nd.

Further, in the timing recovery system circuit 20, a frequency error detection device 23 detects frequency error information between the frequency of a current reproduced waveform and a target frequency using the digital reproduced signal outputted from the AD converter 5, and a loop filter 24 controls the frequency from the phase error information and the frequency error information.

Further, VCOs (Voltage Controlled Oscillators) 25 supply synchronization clocks CL to the AD converter 5, the reproduction stream system circuit 10, and the recording and learning circuit 50. Thus, the timing recovery system circuit 20 constitutes a clock generation unit.

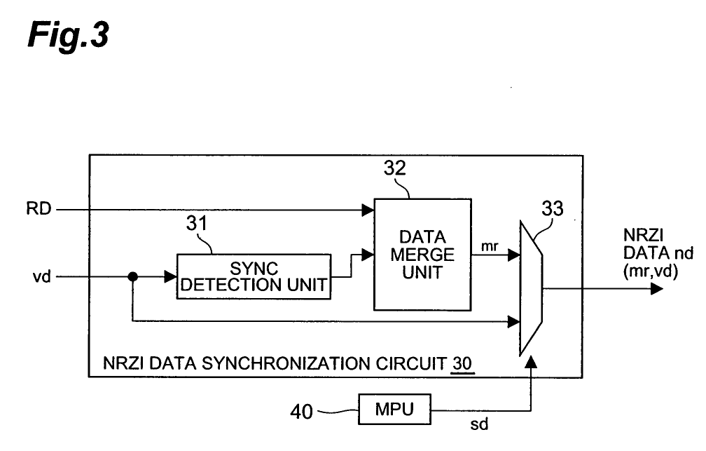

The NRZI synchronization circuit 30, which is a discrimination data output unit, has an SYNC detection unit 31, a data merge unit 32, and a data selection unit 33 as shown in FIG. 3. The NRZI synchronization circuit 30 performs later-described data merge while performing later-described SYNC detection in synchronization to generate merge data mr.

The SYNC detection unit 31 receives input of the Viterbi decoded data vd, performs the SYNC detection of detecting an SYNC code (synchronization code, for example, 13T3T) of the Viterbi decoded data vd, and outputs the detected SYNC code to the data merge unit 32.

The Viterbi decoded data vd has a VFO (Variable Frequency Oscillator) region vd1 and data rows vd2, vd3, vd4, each of which is called frame for every 1116 bits followed by the VFO region.

Further, each frame has at its head an SYNC code (SY0, SY1, SY2, SY3) of 24 channel bits indicating the start position of each frame and has a data portion (Data) following the SYNC code. Record data RD also has a data structure similar to that of the Viterbi decoded data vd. More specifically, record data RD has a VFO region RD1 and data rows RD2, RD3, RD4 followed by RD1.

The data merge unit 32 performs the later-described data merge according to the SYNC code outputted from the SYNC detection unit 31 to generate the merge data mr. The data merge unit 32 further outputs the generated merge data mr to a selection unit 33. The selection unit 33 performs a later-described mode selection based on a mode selection signal sd outputted from the MPU 40, and outputs data according to the mode selected from among the merge data mr and the Viterbi decoded data vd.

Besides, the data outputted from the selection unit 33 is later-described NRZI data nd generated with a NRZI waveform like the record data RD since it is inputted into a pattern discriminator 51 and used for pattern discrimination in the pattern discriminator 51. The NRZI data nd outputted from the selection unit 33 corresponds to the discrimination data.

The data merge in the data merge unit 32 is performed as follows. The data merge by the data merge unit 32 is synchronization merge of merging the record data RD into the Viterbi decoded data vd in synchronization with the Viterbi decoded data vd.

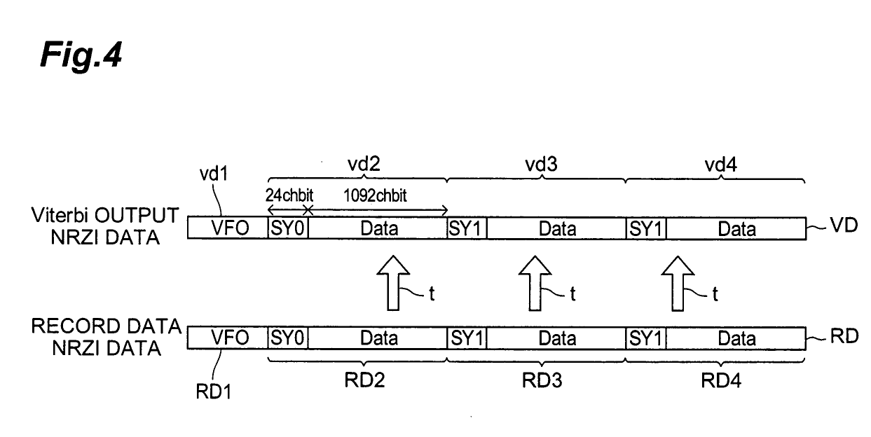

The data merge unit 32 prepares the read record data RD, while detecting the VFO region vd1 to determine the reading start position of the Viterbi decoded data vd. The data merge unit 32 then transfers the data portion (Data) of each of the data rows RD2, RD3, and RD4 in the record data RD to the data portion (Data) of each of the corresponding data rows vd2, vd3, and vd4 in the Viterbi decoded data vd (arrows t in FIG. 4 show transfer of the data portion), while synchronizing the record data RD and the Viterbi decoded data vd using the SYNC code outputted from the SYNC detection unit 31 as a key.

The above operation uses the Viterbi decoded data vd as a base to generate the merge data mr in which the record data RD is merged into the Viterbi decoded data vd. Note that while the VFO region and the SYNC code are used as the record data RD in the information recording and reproducing apparatus 1, these do not need to be used when the record data RD and the Viterbi decoded data vd are different in data structure.

Next, the mode selection by the selection unit 33 means selecting either a recording and learning mode (first mode) or a normal reproduction mode (second mode). The recording and learning mode here is a mode of outputting the merge data mr generated by data merge by the data merge unit 32 from the selection unit 33 to the pattern discriminator 51 in the recording and learning circuit 50.

The normal reproduction mode is a mode of outputting, as the NRZI data nd, the Viterbi decoded data vd from the Viterbi decoder 15 directly to the pattern discriminator 51 in the recording and learning circuit 50. In the normal reproduction mode, the digital data is read from the optical disk D, but the digital data is not recorded, so that recording and learning is not performed. Therefore, the Viterbi decoded data vd is outputted in the normal reproduction mode (in this event, the Viterbi decoded data vd is inputted into a demodulation circuit 55).

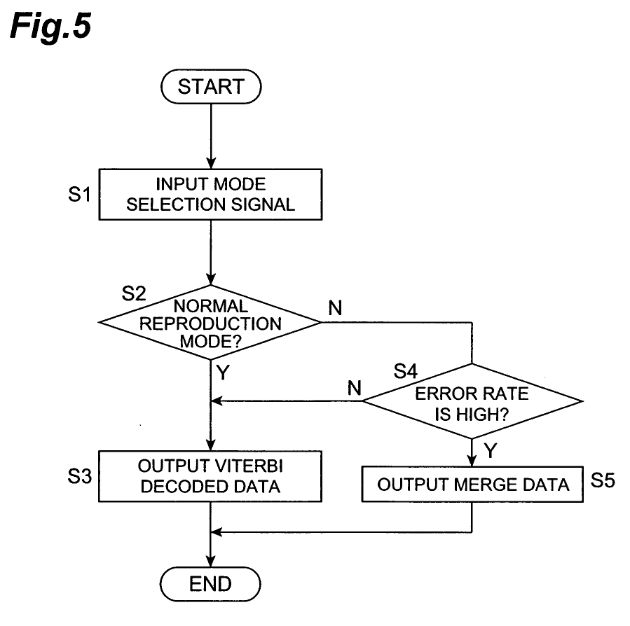

When performing the above-described mode selection, the selection unit 33 executes mode selection processing along a flowchart shown in FIG. 5. After start of the mode selection processing, the selection unit 33 receives input of the mode selection signal sd at block 1 and then advances the processing to block 2 to determine whether or not the inputted mode selection signal sd indicates the normal reproduction mode.

When the mode selection signal sd indicates the normal reproduction mode here, the selection unit 33 advances the processing to block 3, and otherwise advances the processing to block 4. The selection unit 33 outputs the Viterbi decoded data vd as the NRZI data nd when advancing the processing to block 3. When advancing the processing to block 4, the selection unit 33 determines whether the error rate is high or not, and when the error rate is not high, the selection unit 33 advances the processing to block 3, but when the error rate is high, the selection unit 33 regards that the recording and learning mode is selected, and advances the processing to block 5 to output the merge data mr as the NRZI data nd. After block 3 or 5 is executed, the mode selection processing ends.

The recording and learning circuit 50 has the pattern discriminator 51, an ideal signal generation unit 52, a distance difference calculation unit 53, and a parameter calculation unit 54. The recording and learning circuit 50 has a function as the record data correction unit for generating later-described waveform compensation amount data WC (correction data) for correcting the record waveform generated from the record data RD.

In the pattern discriminator 51, several kinds of previously set patterns are registered. Since the NRZI data nd outputted from the NRZI synchronization circuit 30 is inputted into the pattern discriminator 51, the pattern discriminator 51 performs pattern discrimination of discriminating a pattern matching the inputted NRZI data nd. The pattern discriminator 51 then generates a pattern indication signal indicating which pattern of the registered patterns is the same as the matching pattern, and outputs the binary pattern corresponding to the pattern indicating signal to the ideal signal generation unit 52.

The ideal signal generation unit 52 generates an ideal signal according to the PR characteristic to be applied, from the binary pattern supplied from the pattern discriminator 51.

The distance difference calculation unit 53 calculates a distance difference between the ideal signal generated by the ideal signal generation unit 52 and a reproduced signal EQOUT outputted from the delay device 41 (Euclidean distance difference), performs a predetermined operation for the calculated distance difference, and stores the distance difference data obtained by the operation into a not-shown distance difference memory.

The parameter calculation unit 54 performs a predetermined parameter operation based on the distance difference data stored in the distance difference memory at the point in time when a predetermined amount of data is reproduced from the optical disk D to calculate waveform compensation amount data WC of record waveform. The waveform compensation amount data WC is supplied to the record waveform generation unit 70 together with a reference clock RC and the record data RD.

Next, the recording system circuit 60 has a memory 61, a data addition unit 62, a scramble processing unit 63, an encode processing unit 64, a modulation circuit 65, and a DSV control unit 66 so that they generate the record data RD from main data (Main data) MD being original data that has been determined in advance when recorded.

The data addition unit 62 first reads the main data MD from the memory 61 and adds a data ID (four bytes), an IED (Data ID Error Detection Code, two bytes), and an RSV (reservation byte, six bytes) to the read main data MD (2048 bytes).

The data addition unit 62 further adds an EDC (Error Detecting Code, a code for detecting a bit error) of four bytes to the data of 2060 bytes in the above manner to create sector data MD1 of 2064 bytes.

Next, the scramble processing unit 63 performs scramble processing only for the main data MD of the sector data MD1 to create sector data MD2.

Subsequently, the encode processing unit 64 collects 32 pieces of sector data MD2, performs ECC (Error correcting code) encode processing on them, and adds PI and P0 parities to them into the form of an ECC block. The encode processing unit 64 then interleaves P0 to obtain ECC block data MD3 (the data size of the ECC block data MD3 is 75712 bytes in which the PI and P0 parities are added to 32 pieces of sector data MD2).

The ECC block data MD3 in this data structure is sent to the modulation circuit 65. The modulation circuit 65 divides each piece of sector data MD2 into 26 frames, for example, when performing ETM modulation. Each frame includes the SYNC code of 24 channel bits and data of 1092 channel bits and is thus composed of 1116 channel bits (93 bytes) in total.

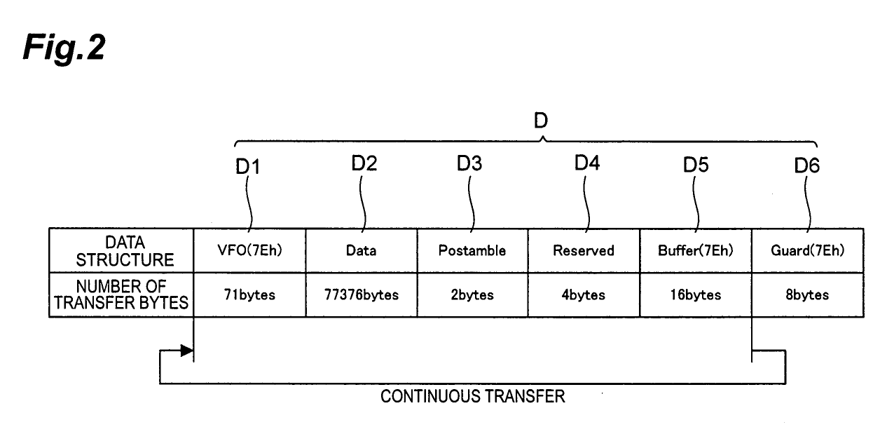

The modulation circuit 65 then generates the recording data D in the structure including the VFO as shown in FIG. 2. In the recording data D, items D1 (VFO), D2 (Data), D3 (Postamble), D4 (Reserved), D5 (Buffer), and D6 (Guard) are provided.

D1 is a VFO pattern generated by ETM-modulating 7E. D2 is 77376 bytes (=93×26×32) because there are 32 pieces of sector data MD2 each for 26 frames, each frame having 93 bytes. D3 indicates the SYNC code, and D4 is generated by modulating 00 h. D5 is used as a buffer, and D6 is added at the time of end of transfer of the recording data D.

Further, the DSV control unit 66 performs DSV control (Digital Sum Value control) when necessary to thereby generate the record data RD.

The record waveform generation unit 70 generates a record waveform pulse EP which is properly compensated in waveform (properly controlled) based on the supplied reference clock RC, record data RD, and waveform compensation amount data WC, and outputs it to the PUH 3.

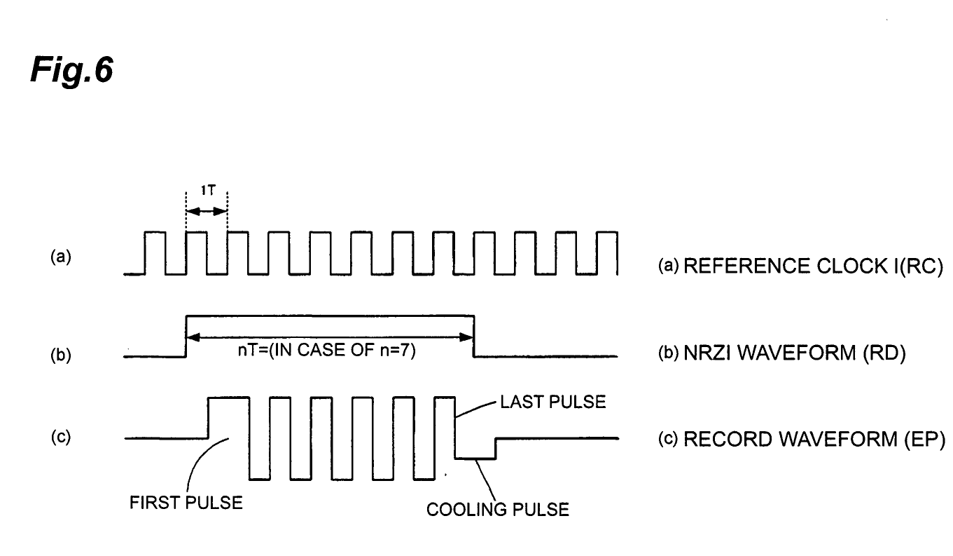

The record waveform generation unit 70 is configured to generate a record waveform pulse EP as shown at (c) in FIG. 6 when it is given a reference clock RC of a cycle T as shown at (a) in FIG. 6 and data of an NRZI (Non-Return to Zero Inverted) waveform with a length of nT as shown at (b) in FIG. 6.

The record waveform generation unit 70 is also configured to correct the record waveform by increasing or decreasing, for example, the pulse width of a head pulse (first pulse) of the record waveform pulse EP shown at (c) in FIG. 6 according to the given waveform compensation amount data WC. Note that when correcting the record waveform, the record waveform generation unit 70 not only increases or decreases the pulse width of the first pulse but may also increase or decrease the width of a last pulse or a cooling pulse.

The internal configuration of the record waveform generation unit 70 which generates the record waveform pulse EP varying according to the reference clock RC, the record data RD, and the waveform compensation amount data WC as described above is disclosed, for example, in Japanese Patent Application Publication(KOKAI)No. 2000-90436 (however, the waveform compensation amount data WCA in the embodiment of Japanese Patent Application No. 2000-90436 is different in contents from the waveform compensation amount data WC in the embodiment of the present invention).

(Operation Contents of Information Recording and Reproducing Apparatus)

The operation contents of the information recording and reproducing apparatus having the above configuration when performing test write will be described.

First, it is assumed that test write of writing the record data RD into the optical disk D on a trial basis is performed in the information recording and reproducing apparatus 1. In this case, the record waveform generation unit 70 generates a record waveform according to the supplied reference clock RC and record data RD, and the record waveform pulse EP is generated which is corrected according to the waveform compensation amount data WC from the record waveform, and the record waveform pulse EP after correction is outputted to the PUH 3. The PUH 3 applies the laser light to the optical disk D according to the record waveform pulse EP so that the record data RD is recorded on the optical disk D.

Subsequently, in the information recording and reproducing apparatus 1, the record data RD written by the test write is read from the optical disk D to generate a reproduced signal, and the reproduction stream system circuit 10 generates the Viterbi decoded data vd using the reproduced signal.

In this case, the PUH 3 and the preamplifier 4 operate to generate the analogue reproduced signal from which the digital reproduced signal is generated by the AD converter 5.

Further, the AGC circuit 11, the offset cancel circuit 12, and the asymmetry cancel circuit 13 controls the amplitude, removes the offset component, and removes the asymmetry component, respectively, of the digital reproduced signal.

Further, the adaptive equalizer 14 and the Viterbi decoder 15 perform signal processing by the PRML system to generate the Viterbi decoded data vd.

In the information recording and reproducing apparatus 1, the NRZI synchronization circuit 30 then generates the NRZI data nd which is inputted into the recording and learning circuit 50.

In this case, the SYNC detection unit 31 detects the SYNC code of the Viterbi decoded data vd. The data merge unit 32 performs the above-described data merge to generate the merge data mr. Further, by performing the recording and learning, the mode selection signal sd indicating the recording and learning mode is inputted from the MPU 40 into the selection unit 33, so that the selection unit 33 outputs the merge data mr as the NRZI data nd.

The NRZI data nd thus generated is inputted into the recording and learning circuit 50, and the recording and learning circuit 50 performs recording and learning. More specifically, the pattern discriminator 51 discriminates a pattern which matches the inputted NRZI data nd. An ideal signal according to the discriminated pattern is generated by the ideal signal generation unit 52. The distance difference between the generated ideal signal and the reproduced signal after waveform equalization which has been adjusted in phase by the delay device 41 is calculated by the distance difference calculation unit 53 and, based on the calculated distance difference, the waveform compensation amount data WC is calculated by the parameter calculation unit 54.

The record waveform generation unit 70 generates the record waveform pulse EP which is properly compensated in waveform based on the reference clock RC, the record data RD, and the waveform compensation amount data WC and outputs it to the PUH 3. The PUH 3 applies the laser light according to the record waveform pulse EP so that the record data RD is recorded on the optical disk D.

The information recording and reproducing apparatus 1 having the above-described configuration and operating as described above has the operational effect as follows.

The Data portion of the Viterbi decoded data vd may include a decoding error occurring when the PUH 3 reads the digital data from the optical disk D to generate the reproduced signal. However, the record data RD is known data before recorded on the optical disk D, unlike the Viterbi decoded data vd based on the reproduced signal, and therefore never includes the decoding error in the Data portion.

Therefore, use of the merge data mr generated by the merge data unit 32 allows the information recording and reproducing apparatus 1 to perform pattern discrimination using the ideal data including no decoding error. Accordingly, the information recording and reproducing apparatus 1 never generates any calculation error when calculating the distance difference by the distance difference calculation unit 53. Thus, the information recording and reproducing apparatus 1 can perform accurate recording and learning.

The pattern discrimination performed using the record data RD requires phase adjustment, which phase adjustment may be difficult in some cases. However, the merge data mr is generated based on the Viterbi decoded data vd (the merge data mr is generated by merging the record data RD into the Viterbi decoded data vd in synchronization therewith), so that the pattern discrimination performed using the merge data mr allows for the phase adjustment with ease as in the case using the Viterbi decoded data vd.

Accordingly, by performing the pattern discrimination using the merge data mr, the information recording and reproducing apparatus 1 can not only perform the pattern discrimination using the ideal data including no decoding error but also eliminate the difficulty in phase adjustment.

In addition, the NRZI synchronization circuit 30 is configured to operate in the recording and learning mode of outputting the merge data mr and in the normal reproduction mode of outputting the Viterbi decoded data vd so that the information recording and reproducing apparatus 1 can select the output mode of the NRZI data nd from among the two modes, the recording and learning mode and the normal reproduction mode.

Further, the NRZI synchronization circuit 30 has the selection unit 33 which selects any one of the two modes, the recording and learning mode and the normal reproduction mode, according to the mode selection signal sd so that one of the two modes, the recording and learning mode and the normal reproduction mode, can be selected also by changing the mode selection signal sd.

Furthermore, the NRZI synchronization circuit 30 outputs the merge data mr only when the error rate is high, whereas it outputs the Viterbi decoded data vd when the error rate is low. Performance of the recording and learning can make the Viterbi decoded data vd ideal data, in this case the merge data mr does not need to be outputted. The NRZI synchronization circuit 30 has a configuration adapted to such requirement.

The equalization error signal generation unit 18 generates the equalization error signal using the ideal signal obtained from the NRZI data nd so that the equalization error signal is free from error. Accordingly, it is possible to set the control gains of the circuits controlled based on the equalization error signal (the AGC circuit 11, the offset cancel circuit 12, the asymmetry cancel circuit 13, and the adaptive equalizer 14) higher, leading to a reduction in the error rate due to the circuits.

The change between the two modes, the recording and learning mode and the normal reproduction mode, changes the NRZI data nd to either the merge data mr or the Viterbi decoded data vd. Therefore, the information recording and reproducing apparatus 1 can also change the control gain of the circuit controlled based on the equalization error signal by performing the mode selection according to the mode selection signal sd.

In the timing recovery system circuit 20, the phase comparator 21 performs phase comparison using the output signal from the asymmetry cancel circuit 13 in the normal reproduction mode. In contrast, in the recording and learning mode, the phase comparator 21 can perform phase comparison using the ideal signal generated by the ideal signal generation circuit 22 (the normal reproduction mode and the recording and learning mode can be switched by the instruction from the MPU 40).

Therefore, pull-in of the phase by the phase comparator 21 can be stably performed to attain a wide capture range, thereby increasing the stability of PLL (Phase Locked Loop).

As the SYNC detection unit 31 of the NRZI synchronization circuit 30, one in the existing decoding circuit can be employed. Therefore, construction of the SYNC detection unit 31 as in the information recording and reproducing apparatus 1 eliminates an increase in the circuit size.

Note that when it can be determined that there is an error at a certain level or greater by performing comparison of the record data RD with the Viterbi decoded data vd while synchronizing using the SYNC code, it can be determined that a defect has occurred. This allows the error to be rejected in real time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording and reproducing apparatus comprising a reproduced signal output unit for reading information recorded on a recording medium and outputting a reproduced signal, a partial response maximum likelihood (PRML) signal processing unit for performing signal processing by a PRML system on the reproduced signal outputted from said reproduced signal output unit, and a record data generation unit for generating record data to be recorded on said recording medium, comprising:
a record data correction unit for generating correction data for correcting a record waveform generated according to the record data; and
a discrimination data output unit for generating discrimination data for use in pattern discrimination performed by said record data correction unit to generate the correction data, using decoded data outputted from said PRML signal processing unit and the record data, and outputting the generated discrimination data to said record data correction unit.

2. The information recording and reproducing apparatus according to claim 1, wherein said discrimination data output unit includes a data merge unit for merging the record data into the decoded data, and outputs merge data generated by said data merge unit as the discrimination data.

3. The information recording and reproducing apparatus according to claim 2, wherein said discrimination data output unit is configured to operate in a first mode of outputting the merge data generated by said data merge unit as the discrimination data and in a second mode of outputting the decoded data as the discrimination data.

4. The information recording and reproducing apparatus according to claim 3, further comprising:
a mode selection signal input unit for inputting into said discrimination data output unit a mode selection signal for allowing said discrimination data output unit to operate either in the first mode or the second mode,
wherein said discrimination data output unit further includes a selection unit for selecting one of the first mode and the second mode according to the mode selection signal inputted from said mode selection signal input unit.

5. The information recording and reproducing apparatus according to claim 2,
wherein said discrimination data output unit further includes a synchronization code detection unit for detecting a synchronization code of the decoded data, and
wherein said data merge unit merges the record data into the decoded data based on the synchronization code detected by said synchronization code detection unit.

6. The information recording and reproducing apparatus according to claim 3,
wherein said discrimination data output unit includes a synchronization code detection unit for detecting a synchronization code of the decoded data, and
wherein said data merge unit merges the record data into the decoded data based on the synchronization code detected by said synchronization code detection unit.

7. The information recording and reproducing apparatus according to claim 4,
wherein said discrimination data output unit includes a synchronization code detection unit for detecting a synchronization code of the decoded data, and
wherein said data merge unit merges the record data into the decoded data based on the synchronization code detected by said synchronization code detection unit.

8. The information recording and reproducing apparatus according to claim 1, wherein said PRML signal processing unit includes:
an amplitude control unit for detecting an amplitude error of the reproduced signal outputted from said reproduced signal output unit and controlling the signal to an appropriate amplitude;
an offset cancel unit for removing an offset component of the reproduced signal controlled by said amplitude control unit;
an asymmetry cancel unit for removing an asymmetry component of the reproduced signal from which the offset component has been removed by said offset cancel unit;
an adaptive equalizer for performing waveform equalization to create a response of partial response (PR) characteristic to be applied for the reproduced signal from which the offset component and the asymmetry component have been removed; and
a Viterbi decoder for performing maximum likelihood sequence estimation based on an output signal from said adaptive equalizer and outputting the decoded data.

9. The information recording and reproducing apparatus according to claim 8,
wherein said PRML signal processing unit further includes an equalization error signal generation unit for generating an equalization error signal using an ideal signal obtained from the discrimination data generated by said discrimination data output unit,
wherein at least one of said amplitude control unit, said offset cancel unit, said asymmetry cancel unit, and said adaptive equalizer is configured to be controlled based on the equalization error signal generated by said equalization error signal generation unit.

10. The information recording and reproducing apparatus according to claim 9, wherein said PRML signal processing unit is configured such that control gains of said amplitude control unit, said offset cancel unit, said asymmetry cancel unit, and said adaptive equalizer vary according to the mode selection signal.

11. The information recording and reproducing apparatus according to claim 8, further comprising:
a clock generation unit for generating a synchronization clock by performing phase comparison of the reproduced signal outputted from said reproduced signal output unit with the reproduced signal from which the asymmetry component has been removed by said asymmetry cancel unit, using the discrimination data outputted from said discrimination data output unit.

12. An information recording and reproducing method applied to an information recording and reproducing apparatus comprising a reproduced signal output unit for reading information recorded on a recording medium and outputting a reproduced signal, a partial response maximum likelihood (PRML) signal processing unit for performing signal processing by a PRML system on the reproduced signal outputted from said reproduced signal output unit, and a record data generation unit for generating record data to be recorded on said recording medium, comprising the steps of:
generating discrimination data for use in pattern discrimination using decoded data outputted from said PRML signal processing unit and the record data, and generating correction data for correcting a record waveform generated according to the record data using the generated discrimination data.
